(19) United States
(12) Patent Application Publication
(10) Pub. No.: US 2006/0247807 A1
(43) Pub. Date: Nov. 2, 2006

(54) Method and system for calculating and communicating golf information

(76) Inventors: Jonathan Bernstein, New York, NY (US); Andrew Higgs, Amport (GB)

Correspondence Address: BINGHAM MCCUTCHEN LLP, 3000 K STREET, NW, BOX IP, WASHINGTON, DC, 20007, US

(21) Appl. No.: 11/103,553

(22) Filed: Apr. 12, 2005

(51) Int. Cl. G06F 19/00

(52) U.S. Cl. 700/91

(57) ABSTRACT

A platform is provided that includes a handheld device that can obtain a Handicap Index for use in calculating a Handicap for a course, a Handicap for one or more holes of a course, a score for a hole of a course, and a score for a round of golf. Calculations can be performed at a remote location and transmitted to the handheld device for display on the handheld device. The device can communicate with other devices having similar functionality to receive and transmit this and other information. The information obtained and calculated can be for one or more golfers on the same or different golf courses.

### BACKGROUND OF THE INVENTION

1. Field of the Invention

The present invention relates to a system, method, and computer program product for calculating and communicating golf information. More particularly, the present invention relates to a system, method, and computer program product for calculating a Handicap and communicating golf information between remote locations.

2. Description of Prior Art

The sport of golf uses a handicap system to make it possible for golfers of differing skill levels to compete against one another on an equitable basis. The United States Golf Association (USGA) Handicap System utilizes a Handicap Index issued by a golf club which follows all of the procedures established in the USGA Handicap System to characterize a golfers skill level. A golfer's Handicap Index is calculated using their best scores from rounds of golf played on a number of courses, such as ten out of the last 20, with appropriate adjustments based on a Course Rating and a Slope Rating given for each course. A golfer's Handicap Index can be made available for peer review to increase reliability and used by a handicap algorithm to calculate a golfer's handicap for a course and for one or more holes of the course.

When a group of golfers get together to play a round of golf they consider each golfer's current Handicap Index so they can compete on an equitable basis and thereby increase their enjoyment from the round. Typically, a calculation of what handicap to assign each golfer in the group for a particular course is based on each golfer's Handicap Index, the Course Rating and the Slope Rating of the course to be played, and the type of round of golf to be played. In order to accurately calculate each golfer's course Handicap, each golfer's Handicap Index must be know in advance as well as the course Rating and course Slope Rating. This information can then be entered into an algorithm to accurately perform the calculations.

Unfortunately, obtaining each golfer's Handicap Index in advance can be difficult since often times the golfer's that will make up the group are not finalized until the day of play. In addition, even if the golfers that make up the group are finalized in advance, a respective golfer in the group may not know their Handicap Index. Moreover, there are times when golfers wish to compete at the same time against one another, but respective golfers are playing on different golf courses. This increases the difficulty in accurately calculating course handicaps since the course Rating and course Slope Rating are different for different courses.

While calculating each golfer's course handicap is helpful in making a round of golf equitable between the golfers in the group, it merely determines the number of strokes to be given between respective golfer's in the group for the entire round. A course handicap does not accurately represent a golfer's handicap for each particular hole in the round and thus does not determine the stroke or strokes that should be given to the golfer for a respective hole in the round. Moreover, once the calculations are performed for each golfer, there is no way for golfers who are competing on different courses to communicate with one another in real time as the round progresses as well as receive and transmit useful information, such as each golfer's position on a respective course and score for a respective hole.

One type of information, in addition to Handicap information, that is beneficial to a golfer on a course is information related to the layout of the course. This type of information is typically disclosed in “yardage books” or “course books” that can be purchase at the pro shop of the course. For avid golfers that play at multiple golf clubs, the purchase of these types of books can result in the collection of a number of different books. These books can take up a considerable amount of space, are easily damaged, and cumbersome to manage and carry.

While on a course a golfer also often needs to communicate with the pro shop of the course. Communication with the pro shop is typically limited to a golfer relaying a message through club employees found on the course or the golfer leaving the course to return to the pro shop. This can have serious consequences in the event of accidents and create general annoyance in the event of lost clubs or needing new golf balls.

There is a need for a method, system, and computer program product for synthesizing a golf Handicap Index to generate a handicap for one or more holes of a golf course. There is need for the method, system, and computer program product to use the Rating of the course and Slope Rating of the course: There is a need for the method, system and computer program product to have access to a golfer's current Handicap Index. There is a need for the method, system, and computer program product to use an algorithm to calculate the handicap of a golfer for each hole in a round of golf. There is a need for the method, system, and computer program product to synthesize golf handicap indexes of golfer's playing on different courses. There is a need for the method, system, and computer program product to synthesize golf handicap indexes based on a type of golf game being played. There is a need for the method, system, and computer program product for allowing real-time communication between golfers playing on different courses. There is a need for the method, system, and computer program product for obtaining information pertaining to a golf course's layout. There is a need for a method, system, and computer program product for communicating with the pro shop of a golf course.

### SUMMARY OF THE INVENTION

According to embodiments of the present invention, a method, system, and computer program product for calculating and communicating golf information are provided. The present invention provides a platform whereby a golfer can obtain a Handicap Index, a Handicap for a course, a Handicap for one or more holes of a course, a score for a hole of a course, a score for a round of golf, a golfer's position information, and information pertaining to a golf course's layout; calculate a Handicap for a course, a Handicap one or more holes of a course; and communicate with another golfer and a pro shop of a course. These functions can be performed with a mobile handheld device wearable on a golf course. The device can communicate with other devices having similar functionality to receive and transmit information. The information obtained and calculated can be for one or more golfers on the same or different golf courses. The functions of the present invention provides for competition between golfers that is more pleasant and equitable.

According to an embodiment of the present invention, a method of synthesizing golf Handicap Indexes includes receiving a set of current Handicap Indexes for a set of golfers, receiving golf course specific information, and calculating, for each golfer in the set of golfers, a handicap at least on hole of the golf course, wherein the handicap for the at least one hole of the golf course determines the stroke penalty to be received for the at least one hole of the golf course. The current Handicap Indexes for the set of golfers can be received from a remote location and manual entry.

In an embodiment of the present invention, the course specific information includes at least one of a course Rating and a course Slope Rating. The course specific information can be received by manual entry and from a remote location.

In an embodiment of the present invention, calculating the handicap for the at least one hole of the golf course includes using an algorithm. Each golfer's handicap for the at least one hole of the golf course is based on each golfer's respective Handicap Index and the course specific information.

In an embodiment of the present invention, the method also includes displaying each golfer's handicap for each hole of the golf course.

In an embodiment of the present invention, the method includes transmitting each golfer's handicap for each hole of the golf course.

### BRIEF DESCRIPTION OF THE DRAWINGS

The above described features and advantages of the present invention will be more fully appreciated with reference to the detailed description and appended figures in which:

FIG. 1 depicts a functional block diagram of an exemplary system in which the present invention can find application;

FIG. 2 depicts a functional block diagram of an exemplary user system depicted in FIG. 1;

FIG. 3 depicts a functional block diagram of an exemplary system depicted in FIG. 1;

FIG. 4 depicts a functional block diagram of an exemplary system depicted in FIG. 1; and

FIG. 5 depicts a method of calculating and communicating golf information according to embodiments of the present invention.

### DETAILED DESCRIPTION OF THE INVENTION

The present invention is now described more fully hereinafter with reference to the accompanying drawings that show embodiments of the present invention. The present invention, however, may be embodied in many different forms and should not be construed as limited to the embodiments set forth herein. Appropriately, these embodiments are provided so that this disclosure will be thorough and complete, and will fully convey the scope of the present invention.

According to embodiments of the present invention, a method, system, and computer program product for calculating and communicating golf information are provided. The present invention provides a platform whereby a golfer can obtain a Handicap Index, a Handicap for a course, a Handicap for each hole of a course, a score for a hole of a course, a score for a round of golf, a golfer's position information, and information pertaining to a golf course's layout; calculate a Handicap for a course, a Handicap for each hole of a course; and communicate with another golfer and a pro shop of a course. These functions can be performed with a mobile handheld device wearable on a golf course. The device can communicate with other devices having similar functionality to receive and transmit information. The information obtained and calculated can be for one or more golfers on the same or different golf courses. The functions of the present invention provides for competition between golfers that is more pleasant and equitable.

A handicap for a course determines the number of penalty strokes to be given to a golfer for an entire round of golf. A handicap for a particular hole in a round defines the number of penalty strokes a golfer should be given for that hole in the round of golf. These number of strokes are added to the number of actual penalty strokes the golfer takes for that hole. This information can be used by a golfer to keep their score for each hole during a round of golf with golfers on the same course and/or golfers on a different course. At the end of the round of golf, a golfer's score for the round can be used to determine their rank among other golfers in a group and to update the golfer's Handicap Index.

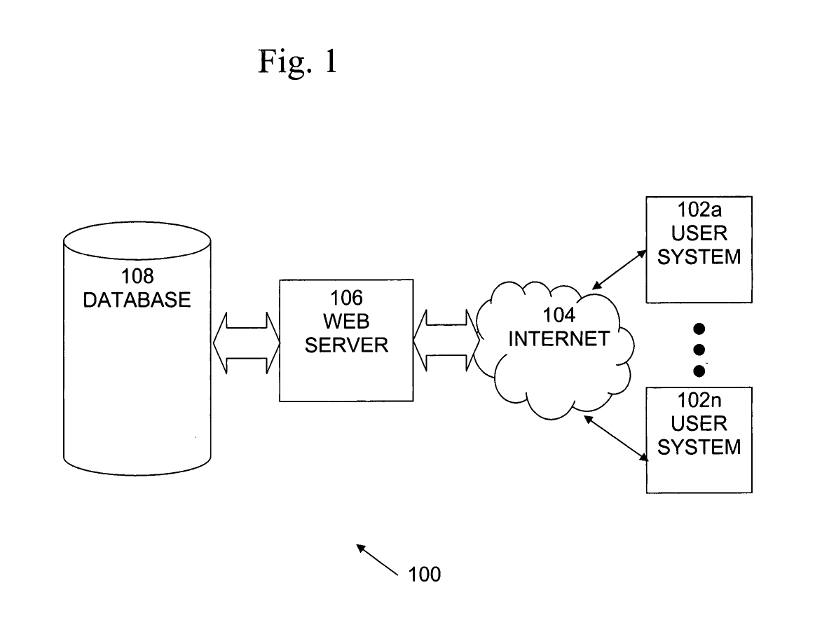

FIG. 1 depicts a functional block diagram of an exemplary system in which the present invention can find application. In the embodiment of FIG. 1, system 100 may be implemented to calculate and communicate golf information. System 100 includes user systems 102a-102n connected to a system 106 employing network 104. System 100 may transmit using network 104, any combination of voice, video and/or data between systems in system 100. User systems 102 may be any apparatus from which, and to which, any combination of voice, video and/or data may be transmitted over a network 104, such as the Internet, a wireless network, a WIFI network, a Bluetooth network and PSTN. User systems 102a-102n can include computers, web access devices, workstations, telecommunication devices, and the like, but can be any device that performs the functions of the present invention. In the FIG. 1 embodiment of the invention, systems 102a-102n are handheld devices. In one embodiment of the invention, systems 102a-102n are a combination of handheld devices and workstations.

System 106 is coupled to system 108 and systems 102a-102n using network 104. System 106 may be any apparatus from which, and to which, any combination of voice video and/or data may be transmitted over a network 104, such as the Internet, a wireless network, a WIFI network, a Bluetooth network and PSTN. System 106 can include computers, web access devices, workstations, telecommunication devices, and the like, but can be any device that performs the functions of the present invention.

System 108 may be any computer that stores structured information managed, developed, and shared by users of system 100. The structured information can be stored in system 108 by individuals authorized to monitor and manage the system 108. One having ordinary skill in the art would recognize that system 108 can be physically or logically connected to system 106.

User systems 102a-102n, system 106 and system 108 can connect to one another by means of a suitable communications network 104. Network 104 can be a local area network, a wide area network, the Internet, a wireless network, a WIFI network, a Bluetooth network, PSTN or the like. The network 104 can transfer information between user systems 102a-102n, system 106, and system 108.

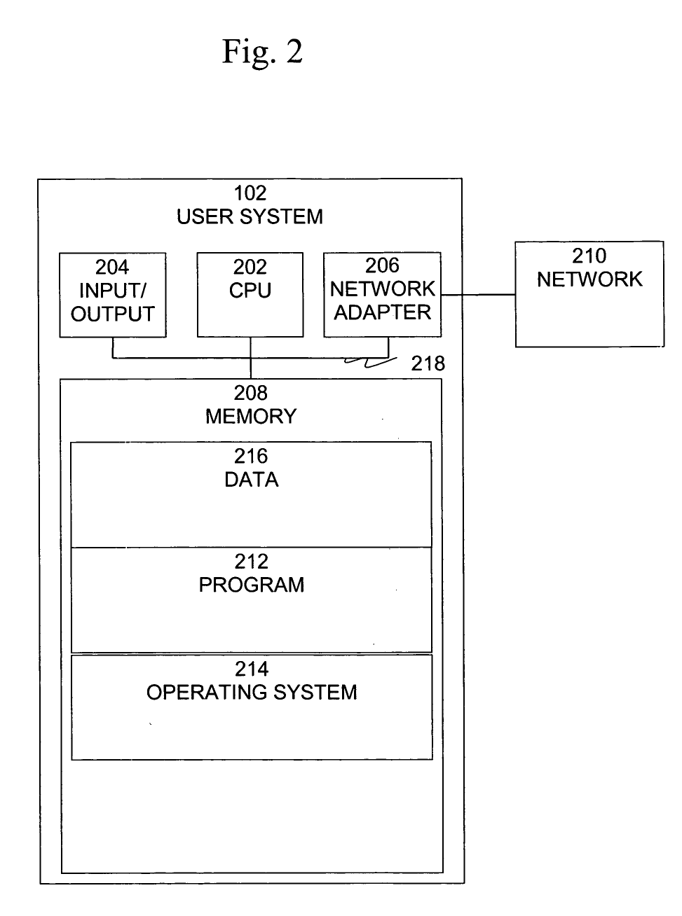

FIG. 2 is an exemplary block diagram of system 102 illustrated in FIG. 1, in which the present invention may be implemented. The user system 102 may include CPU 202, connected by a bus 218 or other suitable interface means to system memory 208. In the FIG. 2 embodiment, CPU 202 is a microprocessor, such as an INTEL PENTIUM® or AMD® processor, but may be any processor that executes program instructions in order to carry out the functions of the present invention. The network interface 206 provides an interface between the system 102 and a network 210, such as the Internet. The network 210 can be a local area network, a wide area network, the Internet, a wireless network, a WIFI network, a Bluetooth network, PSTN, or the like or combinations thereof.

The user system 102 can also include input/output circuitry 204 and network adapter 206. Input/output device interface 204 enables interaction with and execution of instructions by user system 102 as directed by a user. The I/O circuitry 204 provides an interface for the input of structured information to and output of structured information. The I/O circuitry 104 includes input devices, such as trackball, mice, touchpads and keyboards, and output devices, such as printers and monitors. Input/output interface 204 can be used to provide information to system 102 including, but not limited to, a user id and password, Handicap Index data, a course Rating, a course Slope Rating, a golfer's position on a course, and other information. In an embodiment of the present invention, a GPS receiver can be provided as an I/O device enabling the transmission of the location of system 102.

Input/output interface 204 can be used to display Handicap index information, Handicap information for a course, Handicap information for a hole in a round of golf, a golf score, layout information for a golf course and a golfer's position on a course. In an embodiment of the present invention, information displayed is generated by system 102. In an embodiment of the present invention, at least some of the information displayed is generated by system 102 for display. In an embodiment of the present invention, the information displayed is generated by a remote system for display on system 102.

As shown, the various components of the user system 102 communicate through a bus or similar architecture 218. Accordingly, systems memory 208 is disposed in communication with CPU 202 through bus 218. Systems memory 208 includes Program 212, operating system 214, and data 216. Operating system 214 provides overall system functionality. The program 212 enables the information transmitted from system 106 to be conveyed to a user in a manner that can be understood by a user of user system 102. The program 212 serves as a front end to the network 104. In an embodiment of the present invention, program 212 include computer program instructions executed by CPU 202 to perform the functions of transmitting information including, but not limited to, a user id and a password, Handicap Index data, a course Rating, a course Slope Rating, a golfer's position on a course, a number of strokes taken on a hole and other information and receiving Handicap information for a course, Handicap information for a hole in a round of golf, and a golf score. In an embodiment of the present invention, program 212 are computer program instructions executed by CPU 202 to perform the functions of transmitting information including, but not limited to, a user id and a password, Handicap Index data, a course Rating, a course Slope Rating, a golfer's position on a course, a number of strokes taken on a hole and other information, receiving Handicap index information, and calculating Handicap information for a course, Handicap information for a hole in a round of golf, and a golf score. Handicap index information includes, but is not limited to, an actual golfer's Handicap Index, data identifying a golfer to enable access to the golfer's Handicap index and the like.

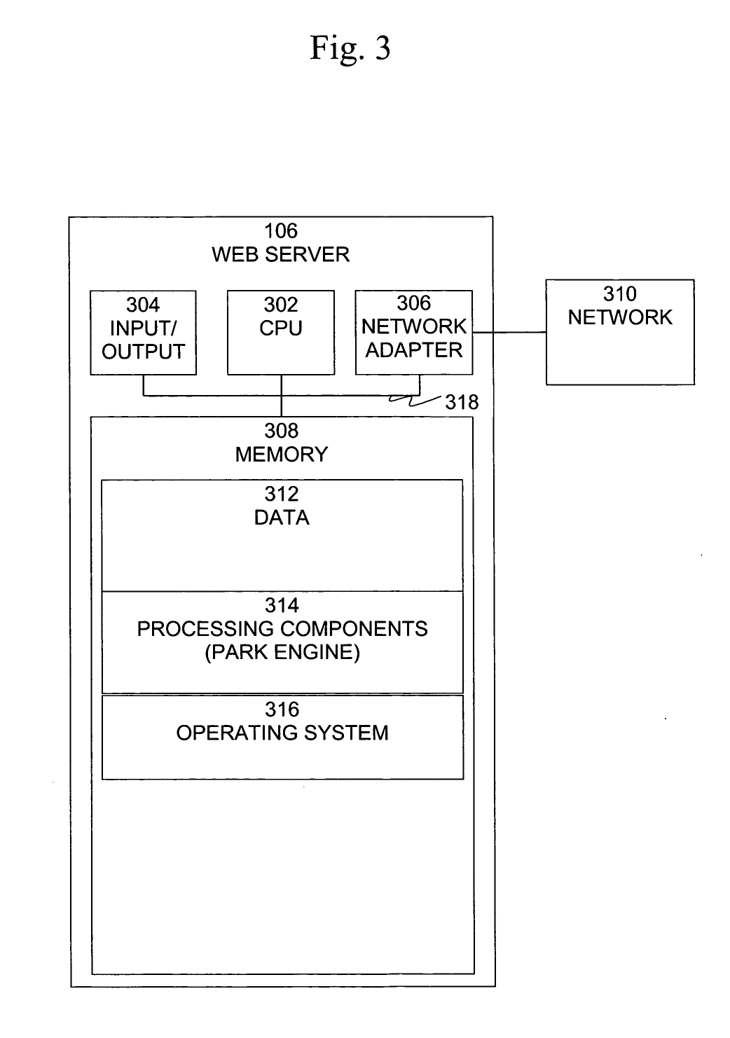

FIG. 3 is an exemplary block diagram of system 106 illustrated in FIG. 1, in which the present invention may be implemented. In an embodiment of the present invention, system 106 performs the functions of maintaining database 108, accessing information stored in database 108 including, but not limited to, a layout for a course and handicap index information, receiving information including, but not limited to, a user id and a password, Handicap Index data, a course Rating, a course Slope Rating, a golfer's position on a course, a number of strokes taken on a hole and other information, calculating a set values including but not limited to, a golf score, a handicap for a course and a handicap for a respective hole of a golf course, and transmitting information including, but not limited to, the calculated information and a layout for a course.

In the FIG. 3 embodiment, system 108 is a general purpose computer, such as a workstation, personal computer, server or the like, but may be any computer that executes program instruction in accordance with the present invention. System 106 includes a processor (CPU) 302 operatively connected by a bus 318 to memory 308, network interface 310 and I/O circuitry 304. In the FIG. 3 embodiment, CPU 302 is a microprocessor, such as an INTEL PENTIUM® or AMD® processor, but may be any processor that executes program instructions in order to carry out the functions of the present invention. Network interface 306 provides an interface between system 106 and a network 310. The I/O circuitry 304 provides an interface for the input of structured information to and output of structured information from system 106. I/O circuitry 304 includes input devices, such as trackball, mice, touchpads and keyboards, and output devices, such as printers and monitors.

In the FIG. 3 embodiment, memory 308 stores application 314, operating system 316 and data 312. As shown, CPU 302 and the various other components of the system 106 communicate through a system bus 318 or similar architecture Operating system 316 provides overall system functionality. Data 312 may be any structured data. The retrieval of the user data may be managed by a data access mechanism. The data access mechanism serves as the means for other application components to retrieve and store user data. In an embodiment of the present invention, application 314 provides the functionality for maintaining database 108, accessing information stored in database 108 including, but not limited to, a layout for a course and handicap index information, receiving information including, but not limited to, a user id and a password, Handicap Index data, a course Rating, a course Slope Rating, a golfer's position on a course, a number of strokes taken on a hole and other information, calculating a set of values including, but not limited to, a golf score, a handicap for a course and a handicap for a respective hole of a golf course, and transmitting information including, but not limited to, the calculated information and a layout for a course.

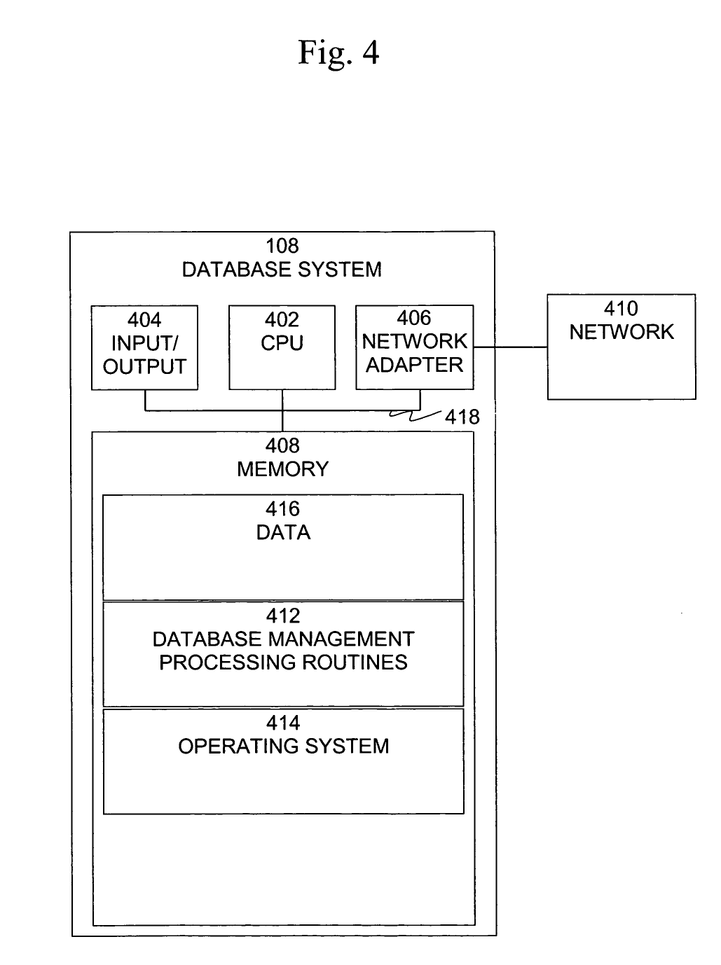

FIG. 4 is an exemplary block diagram of system 108 illustrated in FIG. 1, in which the present invention may be implemented. System 108 comprises a database management system, such as a relational database, that includes structured information developed and shared by users of network 104. In an embodiment of the present invention, system 108 can store information including, but not limited to, a layout of a course and a set of Handicap Indexes for a set of golfer's. In the FIG. 4 embodiment, system 108 is a general purpose computer, such as a workstation, personal computer, server or the like, but may be any computer that executes program instruction in accordance with the present invention. System 108 includes a processor (CPU) 402 connected by a bus 418 to memory 408, network interface 410 and I/O circuitry 404.

In the FIG. 4 embodiment, CPU 402 is a microprocessor, such as an INTEL PENTIUM® or AMD® processor, but may be any processor that executes program instructions in order to carry out the functions of the present invention. As shown, CPU 402 and the various other components of the server 108 communicate through a system bus 418 or similar architecture. Network interface 406 provides an interface between system 108 and a network 410. I/O circuitry provides an interface for the input of structured information to and output of structured information from system 108. I/O circuitry 404 includes input devices, such as trackball, mice, touchpads and keyboards, and output devices, such as printers and monitors.

In the FIG. 4 embodiment, memory 408 stores data obtained using system 100. Memory 408 includes routines, such as database management routines 412, and operating system 414. Memory 408 includes memory devices, such as read only memory (ROM), random access memory (RAM) hard disks, CD-ROMs, floppy disks, optical storage devices, magnetic storage devices, etc. Operating system 414 provides overall system functionality, such as management of routines in memory 412. Management routines 412 provide data management functionality.

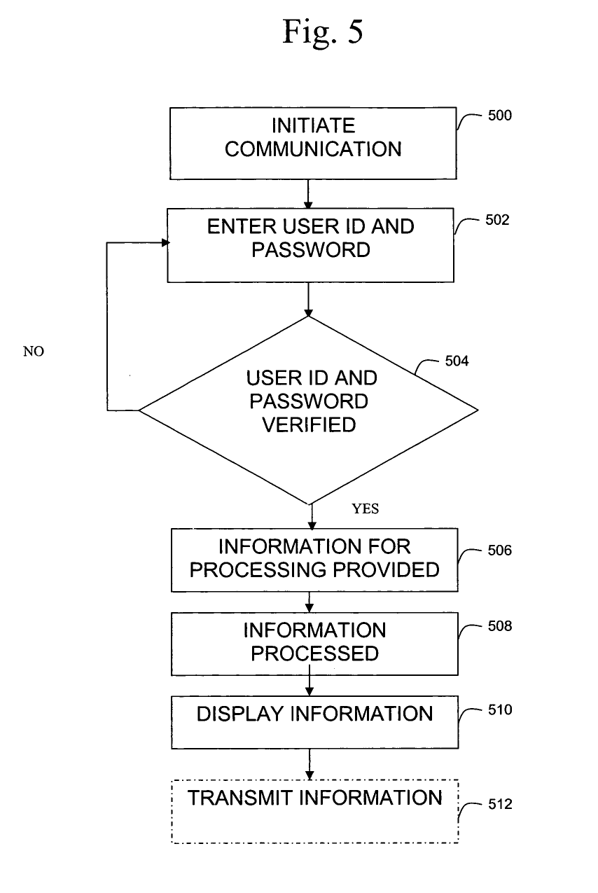

FIG. 5 is an exemplary flow diagram of a method of calculating and communicating golf information according to the present invention. FIG. 5 will be best understood when read in conjunction with FIG. 1. In the FIG. 5 embodiment, the process begins with step 500, in which a golfer initiates communication with system 106 using a system 102. Once a connection is established the process proceeds to step 502. In step 502, the golfer provides their user id and password. In step 504, the golfer's user id and password are verified. If the golfer's user id and password are verified, the process proceeds to step 506. If the golfer's id and password are not verified the process returns to step 502.

In step 506, information is provided for processing. In the FIG. 5 embodiment of the present invention, the golfer inputs information into system 102 for transmission to system 106. In an embodiment of the present invention, processing includes, but is not limited to, calculating a course Handicap and a Handicap for one or more holes of the course for each golfer in a set of golfers, and obtaining course layout information. In an embodiment of the present invention, the information transmitted by system 102 and received by system 106 includes, but is not limited to, Handicap Index data, course name, a course Rating a course Slope Rating or combination thereof. In an embodiment of the present invention, Handicap Index data is provided for each golfer in the set of golfers and includes, but is not limited to, the names of the golfers in the set, the actual Handicap Index for each golfer in the set, the Handicap Index Id for each golfer in the set, or a combination thereof. In an embodiment of the present invention, system 106 can access system 108 and obtain an actual Handicap Index from system 108 using information such as a name and a Handicap Index Id. In an embodiment of the present invention, a golfer in the set of golfers can be playing on a course different from other golfers in the set of golfers. In such a circumstance, a course Rating and a course Slope Rating is provided for each course on which golfers in the set are playing. In an embodiment of the present invention, an automated SMS text message is generated by system 102 and transmitted to a Server (not shown) in response to interaction with system 102. The server (not shown) transmits a streaming video to the system 102 in response to receiving the transmission from system 102.

In step 508, the information provided in step 506 is processed. Processing includes, but is not limited to, calculating a course Handicap and a Handicap for one or more holes of the course for each golfer in a set of golfers, and using the information to obtain course layout information. In an embodiment of the present invention, the provided information is processed at system 106. In an embodiment of the present invention, the provided information is processed at system 102 using information transmitted from system 106, such as a Handicap Index.

In step 510, system 102 displays the processed information. In an embodiment of the present invention, the displayed information includes, at least a course Handicap and a Handicap for each hole of the course for a golfer in a set of golfers, a course layout information or a combination thereof. In an embodiment of the present invention, the processed information is received from system 106 prior to display.

Step 512 is an optional step by which a golfer can use system 102 to transmit information including one or more of the processed information, a score for a hole in a round, information about position on a course, a request by a golfer to a pro shop and the like to another system 102.

While specific embodiments of the present invention have been illustrated and described, it will be understood by those having ordinary skill in the art that changes can be made to those embodiments without departing from the spirit and scope of the invention.

What is claimed is:

1. A method of synthesizing a set of current Handicap Indexes, comprising:
obtaining a Handicap Indexes for at least one golfers;
receiving golf course specific information for at least one golf course; and
calculating for the at least one golfer a handicap for at least one hole of the golf course; wherein the handicap for the at least one hole of the golf course determines the stroke penalty to be received by the golfer for the at least one hole of a golf course.

2. The method according to claim 1, wherein the Handicap Index for the golfer is obtained from a remote location.

3. The method according to claim 1, wherein the Handicap Index for the golfer is received by manual entry.

4. The method according to claim 1, wherein the course specific information includes at least one of: a course Rating and a course Slope Rating.

5. The method according to claim 4, wherein the course specific information is received by manual entry.

6. The method according to claim 4, wherein the course specific information is received from a remote location.

7. The method according to claim 1, wherein calculating for the at least one golfer the handicap for the at least one hole of the golf course includes using an algorithm.

8. The method according to claim 1, wherein the at least one golfer's handicap for the at least one hole of the golf course is based on the at least one golfer's Handicap Index and the course specific information.

9. The method according to claim 1, further comprising displaying the at least one golfer's handicap for the at least one hole of the golf course.

10. The method according to claim 1, further comprising transmitting each golfer's handicap for the at least one hole of the golf course.
